(19) United States
(12) Patent Application Publication
(10) Pub. No.: US 2007/0040532 A1
(43) Pub. Date: Feb. 22, 2007

(54) Motor controller and control method thereof, and error detecting apparatus of inverter

(75) Inventors: Hun-yub Bae, Gwangju (KR); Han-joo Yoo, Gwangju (KR); Koji Hamaoka, Gwangju (KR); Pyeong-ki Park, Gwangju (KR); Jeong-ho Seo, Gwangju (KR); Kwang-kyo Oh, Gwangju (KR); Yun-jeong Kim, Gwangju (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/442,985

(22) Filed: May 31, 2006

(30) Foreign Application Priority Data
Aug. 18, 2005 (KR) 10-2005-0075945

(51) Int. Cl. H02P 27/04

(52) U.S. Cl. 318/801

(57) ABSTRACT

A motor controller, including: a power supply which supplies DC power; an inverter which converts the DC power into AC power to be supplied to a motor; a shunt resistor which connects the power supply and the inverter; and a controller which supplies a control signal to the inverter to drive the motor and determines an error of the inverter when it is determined that a size of voltage between both ends of the shunt resistor is less than a predetermined first reference value. Thus, a motor controller is provided which detects an error of an inverter more easily and precisely, and a control method thereof and an error detecting apparatus of an inverter.

### CROSS-REFERENCE TO RELATED APPLICATION

This application claims the benefit of Korean Patent Application No. 2005-0075945, filed on Aug. 18, 2005, in the Korean Intellectual Property Office, the disclosure of which is incorporated herein by reference.

### BACKGROUND OF THE INVENTION

1. Field of the Invention

The present invention relates to a motor controller and a control method thereof, and an error detecting apparatus of an inverter, and more particularly, to a motor controller which uses voltage between both ends of a shunt resistor to notify an error and error details of an inverter, and a control method thereof and an error detecting apparatus of an inverter.

2. Description of Related Art

Generally, a motor controller comprises: a power supply which supplies DC power; an inverter which converts the supplied DC power into AC power through a switching operation to supply it to a motor; and a controller which controls the switching operation of the inverter.

Here, the inverter is provided as a plurality of switching elements. An over current may cause a break or short-circuit of the inverter due to the characteristics of the switching elements. If the switching elements do not perform their functions, the motor does not normally rotate. Also, it may cause errors in the motor and other parts of the motor controller if the motor continuously operates when the switching elements malfunction. Other than the switching elements, abnormality of an internal wiring of the inverter may cause errors, too.

Accordingly, it is often necessary to detect the error of the inverter sometimes or when necessary. Conventionally, two methods are provided to detect the error of the inverter as follows.

First, the error of the inverter may be detected by the naked eye. That is, a rotation of the motor is directly checked while the motor is driven, by supplying a control signal to the inverter. For example, if the break arises in a part of the switching elements of the inverter, the motor may not rotate or may not rotate smoothly and a predetermined vibration may occur. The detection by the naked eye requires substantial manpower and generally not very accurate.

Second, the error of the inverter may be detected by determining an output of a position detection filter. The position detection filter determines the rotation of a motor rotor, thereby providing information on the rotation of the motor. However, if the motor rotates in a state that the part of the switching elements are broken, it is difficult to determine whether the inverter is broken.

### BRIEF SUMMARY

Accordingly, it is an aspect of the present invention to provide a motor controller which detects an error of an inverter more easily and precisely, and a control method thereof and an error detecting apparatus of an inverter.

According to an embodiment of the present invention, there is provided a motor controller, including: a power supply which supplies DC power; an inverter which converts the DC power into AC power to be supplied to a motor; a shunt resistor which connects the power supply and the inverter; and a controller which supplies a control signal to the inverter to drive the motor and determines an error of the inverter when it is determined that a size of a voltage between ends of the shunt resistor is less than a predetermined first reference value.

The motor controller may also include a display part to display a warning message thereon, wherein the controller may control the display part to display the error of the inverter thereon when it is determined that the inverter is broken.

The controller may include a voltage detector which detects the size of the voltage between both ends of the shunt resistor, and a microcomputer which supplies the control signal to the inverter to drive the motor, and may display a break of at least one switching element included in the inverter, on the display part when it is determined that the size of the detected voltage is less than the predetermined first reference value.

The microcomputer may calculate an average size of the voltage detected for predetermined periods of time, and may display the break of at least one switching element included in the inverter, on the display part when it is determined that the calculated average size of the voltage is less than the first reference value.

The controller may supply the control signal to the inverter to drive the motor and may display the error of the inverter on the display part when it is determined that the size of the voltage between both ends of the shunt resistor is greater than a predetermined second reference value.

The motor may be a BLDC motor.

According to another aspect of the present invention, there is provided a method of controlling a motor controller having a shunt resistor and an inverter, including: a supplying a control signal to the inverter to drive a motor; a detecting a size of a voltage between ends of the shunt resistor; a comparing the size of the detected voltage with a first reference value; and a displaying an error of the inverter when the size of the detected voltage is less than the first reference value.

The method may also include comparing the size of the detected voltage with a second reference value; and a displaying the error of the inverter when the size of the detected voltage is greater than the second reference value.

The method may also include calculating an average size of the voltage detected for predetermined periods of time; and a displaying the error of the inverter when the calculated average size is less than the first reference value or greater than the second reference value.

According to another aspect of the present invention, there is provided an error detecting apparatus of an inverter having a shunt resistor, including: a voltage detector to detect a size of a voltage between ends of the shunt resistor; and a microcomputer to determine an error of the inverter when the size of the voltage detected by the voltage detector is less than a first reference value.

The apparatus may also include a display part to display a warning message thereon, wherein the microcomputer displays the error of the inverter on the display part when it is determined that the inverter is broken.

The microcomputer may display the error of the inverter on the display part when the size of the voltage detected by the voltage detector is greater than a second reference value.

The microcomputer may calculate an average size of the voltage detected for predetermined periods of time, and may display the error of the inverter on the display part when the calculated average size of the voltage is less than the first reference value or greater than the second reference value.

According to another aspect of the present invention, there is provided a motor controlling system, including: a shunt resistor which connects a power supply to a power inverter which converts DC power from the power supply into AC power to be supplied to a motor; and a controller which supplies a control signal to drive a motor to an inverter and determines whether there is an error of the inverter when a size of a voltage between ends of the shunt resistor is less than a predetermined reference value.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a motor controller according to a first embodiment of the present invention;

FIG. 2 is a control flowchart of the motor controller according to the first embodiment of the present invention;

FIG. 3 is a control block diagram of a motor controller according to a second embodiment of the present invention;

FIG. 4a illustrates a waveform of a current flowing in a shunt resistor when an inverter normally operates; and

FIG. 4b illustrates a waveform of a current flowing in the shunt resistor when the inverter is broken.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

### First Embodiment

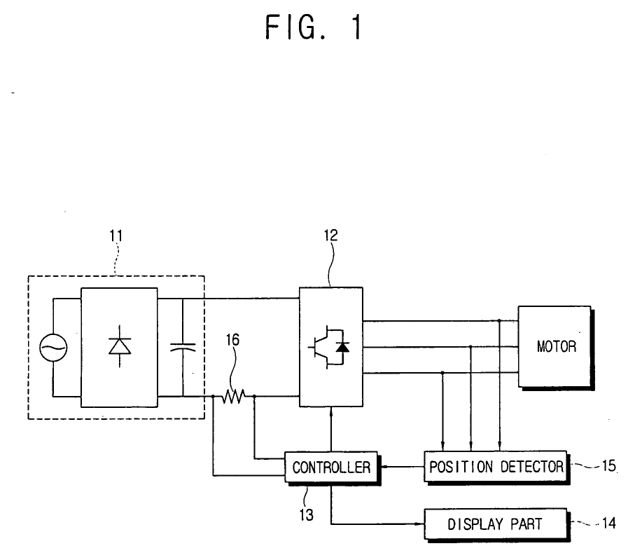

As shown in FIG. 1, a motor controller according to a first embodiment of the present invention comprises a power supply 11, an inverter 12, a shunt resistor 16, a display part 14 and a controller 13. The motor controller according to the first embodiment of the present invention may further comprise a position detector 15.

The power supply 11 may comprise a rectifying circuit which rectifies AC power as commercial power by using a bridge diode; and a smooth circuit such as a capacitor which removes a ripple of the rectified power.

The inverter 12 supplies DC power rectified and smoothed from the power supply 11 to a motor through a switching operation. The inverter 12 includes a switching element but may comprise a plurality of switching elements.

The shunt resistor 16 calculates the quantity of a current supplied to the motor through the inverter 12. The shunt resistor 16 may be provided on a line which connects the power supply 11 and the inverter 12.

The display part 14 displays an error and error details of the inverter 12 by an external control signal. The display part 14 may include a speaker (not shown) to display information through sound, and an LCD (not shown) and an LED (not shown) to display information through a light.

The controller 13 supplies a control signal to the inverter 12 to drive the motor. If the controller 13 determines that a size of voltage between both ends of the shunt resistor 16 is less than a predetermined first reference value, the controller 13 controls the display part 14 to display the error of the inverter 12 thereon.

The controller 13 may comprise a voltage detector (not shown) which detects the size of the voltage between both ends of the shunt resistor 16, and a microcomputer (not shown) which supplies the control signal to the inverter 12 and determines the error of the inverter 12.

Here, the microcomputer may allow the display of information indicating a break of at least one switching element included in the inverter 12, on the display part 14 when it is determined that the size of the voltage between the both ends of the shunt resistor 16 detected by the voltage detector is less than the predetermined first reference value.

Also, the microcomputer may allows the display of information indicating a short circuit of at least one switching element included in the inverter 12, on the display part 14 when it is determined that the size of the voltage between both ends of the shunt resistor 16 detected by the voltage detector is greater than a predetermined second reference value.

Other than the break and the short-circuit of the switching elements, a break and a short-circuit of an internal wiring may display the same error message.

Here, the microcomputer may allow to display the error message if an average size of the voltage between both ends of the shunt resistor 16 is less than the first reference value or greater than the second reference value for predetermined periods of time, instead of directly displaying the error message if the size of the voltage between both ends of the shunt resistor 16 is less than the predetermined first reference value or greater than the predetermined second reference value.

The microcomputer may repeatedly compare voltage between both ends of the shunt resistor and the first and second reference values for predetermined periods of time, and determine that the inverter 12 is broken if the voltage between both ends of the shunt resistor 16 is less than the first reference value or greater than the second reference value by predetermined times or more.

The foregoing methods are used to detect the errors of the inverter 12 more precisely, as external factors may cause the errors even in a very short period of time.

The first reference value and the second reference value may be preset as a predetermined value to detect the errors of the inverter 12 more precisely and quickly.

Meanwhile, the position detector 15 detects the position of the motor rotor and controls a speed and a point of time which proper to shift a phase according to the position of the motor rotor.

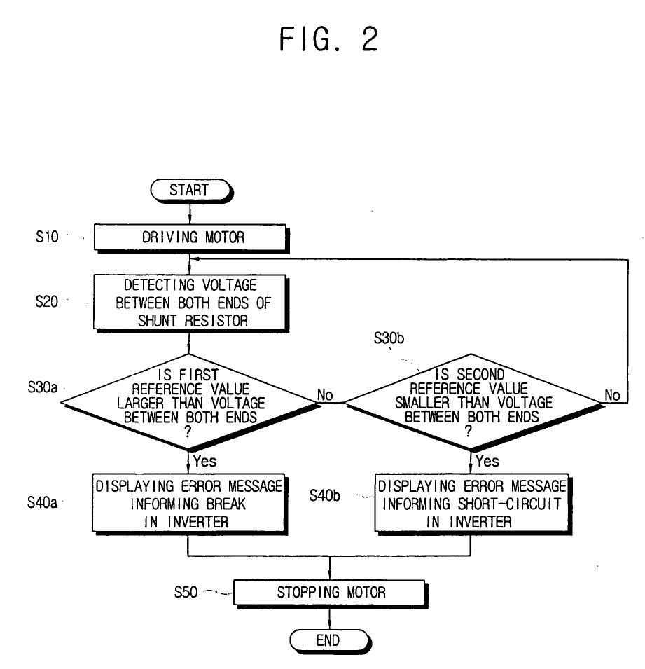

Referring to FIGS. 1 and 2, a control flow of the motor controller according to the first embodiment of the present invention will be described.

First, the microcomputer supplies the control signal to the inverter 12 to drive the motor at operation S10. The voltage detector detects the voltage between both ends of the shunt resistor 16 at operation S20.

Based on a detection result of the voltage detector, if the voltage between both ends of the shunt resistor 16 is less than the predetermined first reference value at operation S30a, the microcomputer displays the error message informing the break of the inverter, on the display part 14 at operation S40a.

Meanwhile, if it is detected by the voltage detector that the voltage between both ends of the shunt resistor 16 is greater than the predetermined second reference value at operation S30b, the microcomputer displays the error message informing the short-circuit of the inverter 12, on the display part 14 at operation S40b.

Here, the average value of the voltage between both ends of the shunt resistor 16 may be compared to the first reference value and the second reference value for predetermined periods of time to prevent mistakes in detecting the errors.

The microcomputer controls the inverter 12 to stop the motor after displaying the break or the short-circuit of the inverter 12 on the display part 14 at operation S50.

### Second Embodiment

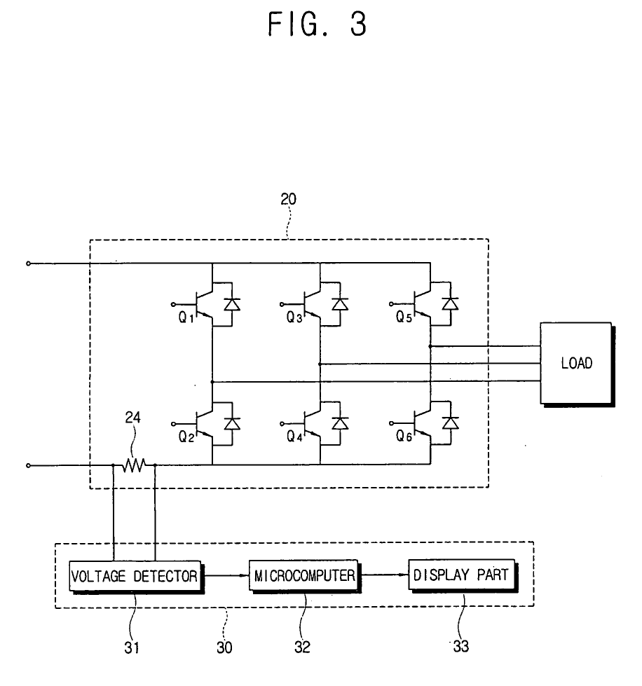

As shown in FIG. 3, an error detecting apparatus 30 of an inverter 20 according to a second embodiment of the present invention comprises a voltage detector 31, a microcomputer 32 and a display part 33.

As shown therein, the inverter comprises a shunt resistor 24.

As described in the first embodiment, the inverter 10 may comprise a plurality of switching elements, and converts DC power into AC power through a switching operation of the switching elements, to be supplied to a load.

FIG. 3 does not illustrate a control circuit which controls the inverter 20, a position detector and a motor to simplify the drawing.

The error detecting apparatus 30 comprises a terminal which is contactable to both ends of the shunt resistor provided in the inverter. As an example of the present embodiment, the terminal may be provided as two lead lines.

While the inverter 20 operates, the voltage detector 31 may detect voltage between both ends of the shunt resistor 24 if the lead lines are contacted to the both ends of the shunt resistor. At this time, the voltage detector 31 may comprise: a signal amplifier (not shown) employing an OP AMP; and an A/D converter (not shown) converting an amplified analog signal into a digital signal to detect the voltage between both ends.

If the voltage between both ends of the shunt resistor 24 detected by the voltage detector 31 is less than a preset first reference value, the microcomputer 32 determines that the switching elements of the inverter are broken and displays an error message on the display part 33.

A break of Q2 will be described as an example.

When Q5 and Q4 are turned on, a current is supplied to the load through Q5, and flows to the shunt resistor 24 through Q4. When Q5 and Q2 are turned on by a phase shift, the current sequentially flows to Q5, the load, Q2 and the shunt resistor 24. However, the current may not flow in that sequence due to the break of Q2. Also, the current may not flow in that sequence if Q3 and Q2 are turned on by a next phase shift.

However, even if the current may not flow temporarily, a motor rotor may rotate by inertia. At this time, if Q3 and Q6 are turned on to flow the current through the load, the motor may seem to rotate continuously. However, as the voltage between both ends of the shunt resistor 24 is close to 0 by the phase shift through Q2, the microcomputer 32 may determine whether the switching elements of the inverter are broken through a detection result of the voltage detector 31.

If the switching elements are short-circuited due to damage thereof, the voltage between both ends of the shunt resistor 24 rises as the current flowing through the shunt resistor 24 increases.

Then, the microcomputer 32 compares the detection result of the voltage detector 31 and the predetermined second reference value, and displays the error message informing the short-circuit of the inverter 20 on the display part 33 if it is determined that the voltage between both ends of the shunt resistor 24 is greater than the second reference value.

An over current protecting circuit is generally provided in most circuits. If the over current protecting circuit does not properly operate, the error detecting apparatus 30 of the inverter according to the second embodiment of the present invention may detect an error or may inform whether the inverter 20 is short-circuited even before preventing the over current through the over current protecting circuit.

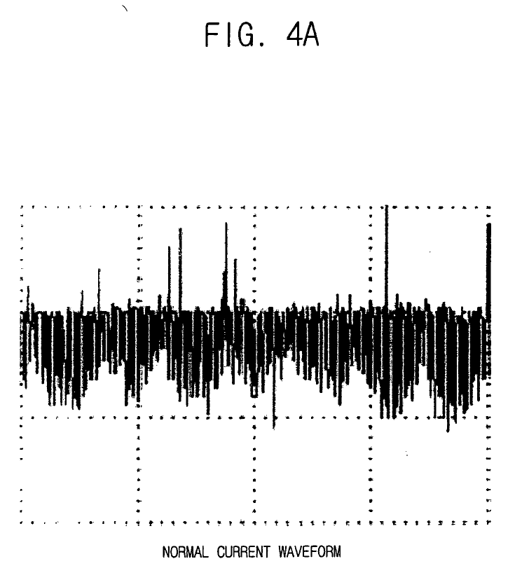

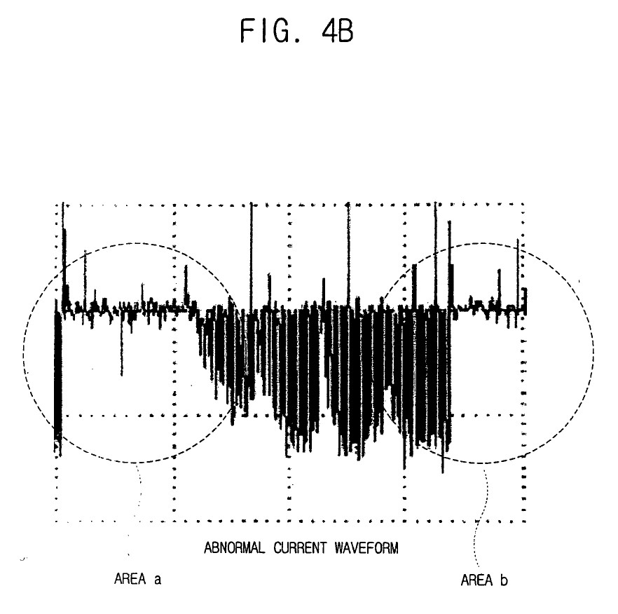

FIGS. 4a and 4b respectively illustrate waveforms of the current flowing through the shunt resistor 24 when the inverter is not broken and when a part of the switching elements of the inverter 20 is broken.

Unlike the waveform in FIG. 4a, in the current waveform in FIG. 4b, the current drastically decreases in areas “a” and “b”.

If the current drastically decreases in a certain area, the microcomputer 32 determines that the voltage between both ends of the shunt resistor 24 is less than the predetermined first reference value and detects the break of the inverter.

That is, the motor controller according to the above-described embodiments of the present invention may be provided to drive a brushless direct current (BLDC) motor. The BLDC motor is frequently employed in home electronic appliances, particularly in a compressor of a refrigerator.

The BLDC motor drastically decreases a wearing of a mechanical contact point and electrical noise than a conventional DC motor, and controls a rotation speed precisely.

The BLDC motor employed in the compressor of the refrigerator requires the inverter controlled through a pulse width modulation (PWM) control signal. Accordingly, if the error of the inverter is detected, the problem of the overall performance of the refrigerator may be detected earlier. As described above, even if a part of the inverter is broken, the BLDC motor may rotate, thereby hardly informing the errors. Thus, a user may use the refrigerator with the BLDC motor having the errors. The foregoing problem may be solved by the present invention which precisely detects the error of the inverter.

Meanwhile, embodiments of the present invention is applicable to various apparatuses other than the BLDC motor employed in the compressor of the refrigerator, as long as they employ the inverter.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A motor controller, comprising:
a power supply which supplies DC power;
an inverter which converts the DC power into AC power to be supplied to a motor;
a shunt resistor which connects the power supply and the inverter; and
a controller which supplies a control signal to the inverter to drive the motor and determines an error of the inverter when a size of a voltage between ends of the shunt resistor is less than a predetermined first reference value.

2. The motor controller according to claim 1, further comprising a display part which displays information indicting an error thereon,
wherein the controller controls the display part to indicate the error of the inverter thereon.

3. The motor controller according to claim 2, wherein the controller comprises a voltage detector which detects the size of the voltage between ends of the shunt resistor, and a microcomputer which supplies the control signal to the inverter to drive the motor, and causes a display of a break of at least one switching element in the inverter, on the display part when the size of the detected voltage is less than the predetermined first reference value.

4. The motor controller according to claim 3, wherein the microcomputer calculates an average size of the voltage detected for predetermined periods of time, and causes a display of the break of at least one switching element in the inverter, on the display part when the calculated average size of the voltage is less than the first reference value.

5. The motor controller according to claim 2, wherein the controller supplies the control signal to the inverter to drive the motor and displays the error of the inverter on the display part when the size of the voltage between ends of the shunt resistor is greater than a predetermined second reference value.

6. The motor controller according to claim 1, wherein the motor comprises a brushless direct current (BLDC) motor.

7. The motor controller according to claim 2, wherein the motor comprises a brushless direct current (BLDC) motor.

8. The motor controller according to claim 3, wherein the motor comprises a brushless direct current (BLDC) motor.

9. The motor controller according to claim 4, wherein the motor comprises a brushless direct current (BLDC) motor.

10. The motor controller according to claim 5, wherein the motor comprises a brushless direct current (BLDC) motor.

11. A method of controlling a motor controller having a shunt resistor and an inverter, comprising:
a supplying a control signal to the inverter to drive a motor;
a detecting a size of a voltage between ends of the shunt resistor;
a comparing the size of the detected voltage with a first reference value; and
a displaying an error of the inverter when the size of the detected voltage is less than the first reference value.

12. The method according to claim 11, further comprising:
comparing the size of the detected voltage with a second reference value; and
displaying the error of the inverter when the size of the detected voltage is greater than the second reference value.

13. The method according to claim 12, further comprising:
a calculating an average size of the voltage detected for predetermined periods of time; and
a displaying the error of the inverter when the calculated average size is less than the first reference value or greater than the second reference value.

14. An error detecting apparatus of an inverter having a shunt resistor, comprising:
a voltage detector which detects a size of a voltage between ends of the shunt resistor; and
a microcomputer which determines an error of the inverter when the size of the voltage detected by the voltage detector is less than a first reference value.

15. The apparatus according to claim 14, further comprising a display part which displays a warning message thereon, wherein
the microcomputer causes the display of an indication of the error of the inverter on the display part when determined that the inverter is broken.

16. The apparatus according to claim 15, wherein the microcomputer causes the display of an indication of the error of the inverter on the display part when the size of the voltage detected by the voltage detector is greater than a second reference value.

17. The apparatus according to claim 16, wherein the microcomputer calculates an average size of the voltage detected for predetermined periods of time, and causes the display of an indication of the error of the inverter on the display part when the calculated average size of the voltage is less than the first reference value or greater than the second reference value.

18. A motor controlling system, comprising:
a shunt resistor which connects a power supply to a power inverter which converts DC power from the power supply into AC power to be supplied to a motor; and
a controller which supplies a control signal to drive a motor to an inverter and determines whether there is an error of the inverter when a size of a voltage between ends of the shunt resistor is less than a predetermined reference value.
